(19) United States
(12) Patent Application Publication
(10) Pub. No.: US 2007/0001593 A1
(43) Pub. Date: Jan. 4, 2007

(54) Image display device

(76) Inventors: Masakazu Sagawa, Inagi (JP); Hiroshi Kikuchi, Zushi (JP); Yukio Takasaki, Kawasaki (JP); Tomoki Nakamura, Chiba (JP); Toshiaki Kusunoki, Tokorazawa (JP); Kazutaka Tsuji, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/472,397

(22) Filed: Jun. 22, 2006

(30) Foreign Application Priority Data
Jun. 22, 2005 (JP) 2005-181459

(51) Int. Cl. H01J 1/62

(52) U.S. Cl. 313/506

(57) ABSTRACT

The present invention provides an image display device, in which a top electrode is selectively separated by laser ablation for each scan line. As the laser, a third harmonic wave of YAG laser with a wavelength of 355 nm is used. By setting film thickness of the interlayer insulator 15 to 100 nm and film thickness of a field insulator 14 to 140 nm, reflective spectrum has the minimum value near a wavelength of 355 nm, This laser beam is projected from a top electrode 13 toward a substrate 10. A part of the projected laser beam 20 is reflected by the top electrode 13, but most of the laser beam pass through a field insulator 14 and the interlayer insulator 15 and is reflected by a bottom electrode 11. As the result of interference of these two reflection waves, the minimum value appears in reflection spectrum. In this case, the laser beam is mostly absorbed near boundary surface between the top electrode 13 and the interlayer insulator 15. The top electrode 13 is processed by ablation (melting and evaporation), and the top electrode 13 is separated at this portion. By utilizing interference phenomenon in this manner, no damage is given to the interlayer insulator 13, the field insulator 14, and the bottom electrode 11, which serve as underlying layers, and the top electrode 13 can be selectively cut off.

### FIELD OF THE INVENTION

The present invention relates to an image display device. In particular, the invention relates to an image display device, also called a self-emitting type flat panel display, using a thin film type electron source array. The invention also relates to a method for manufacturing the same.

### BACKGROUND ART

A type of image display device (field emission display (FED)) is now being developed, which uses a micro-size and integratable electron emission type electron source, also called thin film electron source. In this type of image display device, the electron source is classified to electron emission type electron source and hot electron type electron source. A spint type electron source, a surface conduction type electron source, a carbon nano-tube type electron source, etc. belong to the former, and thin film type electron source such as MIM (metal-insulator-metal) type laminated with metal-insulator-metal, MIS (metal-insulator-semiconductor) type laminated with metal-insulator-semiconductor, and metal-insulator-semiconductor-metal type, etc. belong to the latter.

The MIM type in described in the Patented Reference 1, for instance. On the metal-insulator-semiconductor type, MOS type is described (in the Non-Patented Reference 1). As metal-insulator-semiconductor-metal (MIS) type, REED type is described (in the Non-Patented Reference 2). Also, EL type (described in the Non-Patented Reference 3 and others), porous silicon type (described in the Non-Patented Reference 4), surface conduction (SED) type (described in the Non-Patented Reference 5), etc. are reported.

The MIM type electron source is also disclosed in the Patented Reference 2, for instance. The structure and the operation of the MIM type electron source are as given below. Specifically, an insulator is interposed between the top electrode and the bottom electrode. By applying voltage between the top electrode and the bottom electrode, electrons near Fermi level in the bottom electrode pass through the barrier by tunneling phenomenon. The electrons are turned to hot electrons injected to a conduction band of the insulator, serving as an electron accelerator, and the electrons enter the conduction band of the top electrode. Among these hot electrons, those having energy of work function φ or more of the top electrode and reaching the surface of the top electrode are emitted into vacuum.

As to be described later, a laser beam is used for the separation of the scan lines (top electrode of the electron source) in the present invention. As the conventional examples using the laser beam for the manufacture of this type of image display device, those described in the Patented Reference 3, the Patented Reference 4, the Patented Reference 5, and the Patented Reference 6 are known.

[Patented Reference 1] JP-A-7-65710

[Patented Reference 2] JP-A-10-153979

[Patented Reference 3] JP-A-2003-16923

[Patented Reference 4] JP-A-2000-133119

[Patented Reference 5] JP-A-2000-82391

[Ron-Patented Reference

1] J. Vac. Sci. Technol; B11(2), pp. 429-432 (1993).

[Non-Patented Reference 2] Sigh Efficiency Electron Emission Device; Jpn. J. Appl. Phys.; Vol. 36; p. 939.

[Non-Patented Reference 3] Electroluminescence, Jpn. J. Appl. Phys.; Vol. 63, No. 6; p. 592.

[Non-Patented Reference 4] Jpn. J. Appl. Phys.; Vol. 66, No. 5; p. 437.

[Non-Patented Reference 5] Journal of SID '97; p. 345.

### DISCLOSURE OF THE INVENTION

### Problems to be Solved by the Invention

In this type of image display device, for the purpose of separating the top electrode serving as the scan line for each scan line, a method is known, by which the metal film to cover the display region and to serve as the top electrode is automatically separated by the so-called self-alignment when the meal film is deposited over the entire area by vacuum evaporation such as sputtering. In this separation to each scan line by the self-alignment, it is so designed that the top electrode deposited over the entire region is automatically separated between adjacent scan lines by incorporating an overhang structure in the scan line bus electrode.

However, the so-called photolithographic process must be performed by three times for the separation by self-alignment, and this hinders the reduction of the manufacturing cost. Also, the separation by self-alignment cannot be executed over the entire area of the display region. In order to restore the defects thus caused, further process must be adopted.

It is an object of the present invention to provide an image display device, by which it is possible to separate the top electrode for each scan line instead of using the self-alignment method as described above. Also, the present invention provides an image display device and a method for manufacturing the same, wherein, even when perfect separation is not performed for each scan line in the conventional type self-alignment separation method, it is possible to restore the defects and to reliably perform the separation for each scan line.

### Means for Solving the Problems

To attain the above object, the present invention provides an image display device, configured in a vacuum container, comprising a cathode substrate arranged in matrix-like form with a multiple of electron sources arranged in a display region, a phosphor substrate having a phosphor layer and an anode corresponding to each of the electron sources, and a sealing frame interposed between said cathode substrate and said phosphor substrate on circumference of the display region and for attaching the substrates with each other, said image display device further comprises:

a multiple of data lines arranged in parallel to said cathode substrate;

a multiple of scan lines arranged in parallel in a direction to perpendicularly cross said data line; and

an electron emitting electrode for emitting electrons in contact with the electron source under vacuum condition;

wherein said electron emitting electrode has a region with locally high resistance and, in said region, crystallization and aggregation are induced is divided to a plurality of independent electrodes.

### Effects of the Invention

According to the present invention, the photolithographic process necessary for the self-alignment method can be eliminated, and the separation of the scan lines can be executed in reliable manner and at low cost. Also, poor or defective separation caused by the self-alignment method can be restored by laser ablation according to the present invention.

### BRIEF DESCRIPTION OF THE DRAWINGS

FIG. 1 shows drawings, each representing an electron source on a cathode substrate to explain a first embodiment of the image display device of the present invention;

FIG. 2 is a schematical drawing to explain separation of a top electrode on a data line;

FIG. 3 is a schematical drawing to explain separation of the top electrode without the data line;

FIG. 4 shows drawings, each representing an electron source on a cathode substrate to explain a second embodiment of the image display device of the present invention;

FIG. 5 is a plan view of a cathode substrate, which constitutes the image display device of the present invention;

FIG. 6 is a drawing to explain the entire configuration of the image display device of the present invention;

FIG. 7A is a SEM photograph of a region in plan view, to which a laser beam is projected on the top electrode on the data line as shown in FIG. 2;

FIG. 7B is a SEM photograph of a region in cross-sectional view where a laser beam is projected to the top electrode on the data line as shown in FIG. 2;

FIG. 7C is a SEM photograph of a region in cross-sectional view where a laser beam is not projected to the top electrode on the data line as shown in FIG. 2; and

FIG. 8 shows the results of measurement on resistance on type 17 VGA panel where the top electrode is separated in the present invention.

### THE BEST MODE FOR CARRYING OUT THE INVENTION

Detailed description will be given below on embodiments of the present invention referring to the drawings. Hereinafter, description will be given on the embodiments of the invention by taking an example on MIM type (metal-insulator-metal) type cathode, while the invention may be applied to the other thin film type cathode in the same manner.

### Embodiment 1

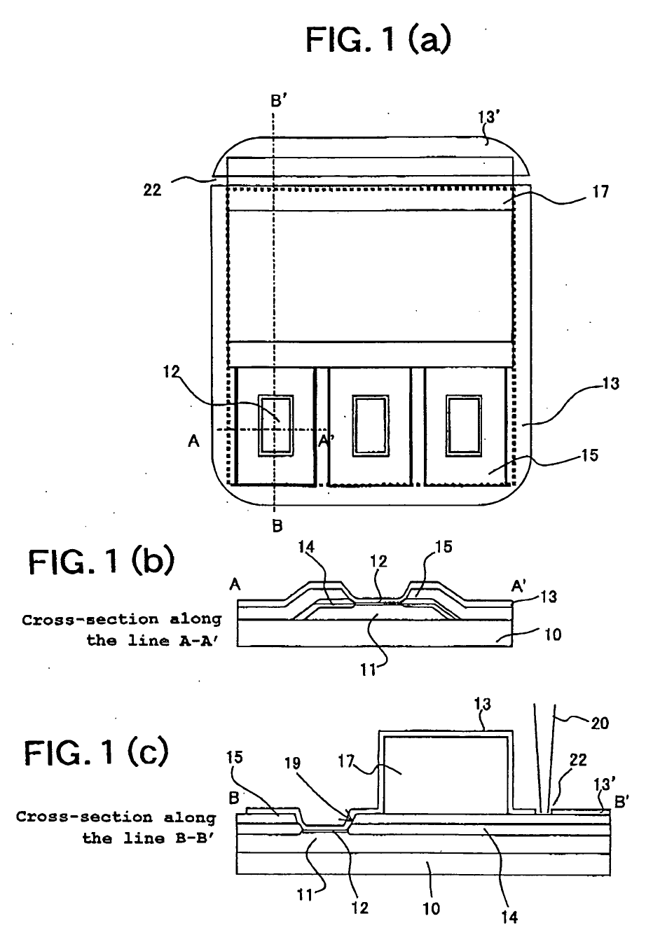

FIG. 1 represents drawings each showing an electron source on a cathode substrate to explain the Embodiment 1 of an image display device according to the present invention. FIG. 1(a) is a plan view of a color pixel, FIG. 1(b) is a cross-sectional view along the line A-A′ in FIG. 1(a), and FIG. 1(c) is a cross-sectional view along the line B-B′ of FIG. 1(a). On the cathode substrate, a data line made of aluminum or alloy of aluminum and neodymium (Al—Nd) as a bottom electrode 11 of the electron source is prepared on inner surface of a cathode substrate 10, which is preferably made of glass. In this case, Al—Nd is used.

The surface of the bottom electrode 11 is processed by anodic oxidation, and a tunneling insulator 12 is prepared on the electron source and a field insulator 14 is formed on the other bottom electrode 11 by anodic oxidation.

Also, a top electrode 13, electrically fed by a scan line 21, is disposed to cross (normally perpendicularly) via insulators (the field insulator 14 and the interlayer insulator 15), and the electron source is arranged in matrix-like form at an intersection. Silicon nitride (SiN) is used for the interlayer insulator 15, The electron source is prepared as a laminated layer, comprising the bottom electrode 11, the tunneling insulator 12, which is an electron accelerator prepared by processing the surface of the bottom electrode 11 by anodic oxidation, and the top electrode 13.

Over the entire surface of the substrate 10, including the scan line 21, the interlayer insulator 15 and the tunneling insulator 12, the top electrode 13 of the electron source is formed by using a laminated thin film of iridium, platinum and gold. The top electrode 13 is deposited over the entire surface as a thin film common to a top electrode 13′, which serves as an adjacent scan line.

A laser light 20 is projected in a direction parallel to the scan line bus 21 between the top electrode 13 and the top electrode 13′ and the separation is performed. FIG. 1(c) shows a condition where the top electrode 13 and the top electrode 13′ are separated from each other. As a result, the top electrode 13 is separated from the top electrode 13′ adjacent to it as shown in upper portion of FIG. 1(a). In Embodiment 1, photolithographic process is required only for once for the formation of the scan line 21.

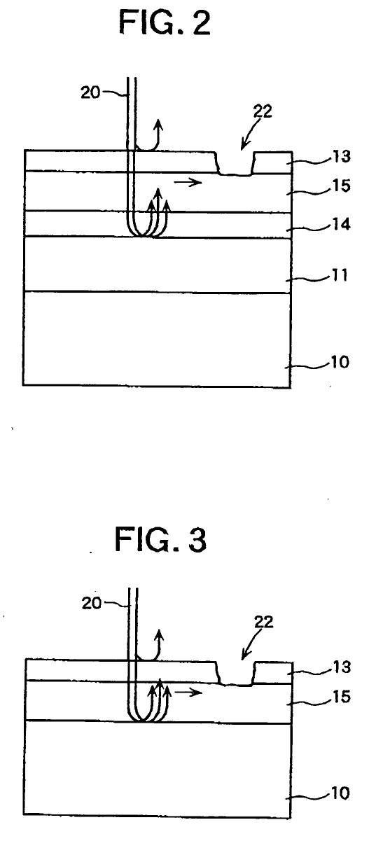

FIG. 2 is a schematical drawing to explain separation of the top electrode on the data line. FIG. 3 is a schematical drawing to explain separation of the top electrode on a region where there is no data line. In FIG. 2 showing a region where the data line is disposed, the data line (the bottom electrode 11) is formed on the cathode substrate 10, and the top electrode 13 is deposited on it via the field insulator 14 and the interlayer insulator (SiN) 15.

As the laser beam, a third harmonic wave of YAG laser with a wavelength of 355 nm is used. By setting film thickness of the interlayer insulator 15 to 100 nm and film thickness of the field insulator 14 to 140 nm, reflection spectrum is turned to the minimum value near a wavelength of 355 nm. This laser beam 20 is projected to the substrate 10 from the top electrode 13. A part of the projected laser beam 20 is reflected by the top electrode 13, while most of the laser beam pass through the field insulator 14 and the interlayer insulator 15 and is reflected by the bottom electrode 11. By interference of these two reflected waves, the minimum value appears on the reflection spectrum. In this case, the laser beam is mostly absorbed near boundary surface between the top electrode 13 and the interlayer insulator 15. The top electrode 13 is melted and re-crystallized, and the top electrode 13 is separated at this portion.

By utilizing interference phenomenon in this way, the top electrode 13 can be selectively cut off without giving any damage to the interlayer insulator 15, the field insulator 14 and the bottom electrode 11, serving as the underlying layers.

FIG. 3 shows a region without the data line, and the interlayer insulator (SiN) 15 is deposited on the cathode substrate 10 and the top electrode 13 is deposited on upper layer. Similarly to FIG. 2, the laser beam 20 is projected toward the substrate 10 from the top electrode 13. A part of the projected laser beam 20 is reflected by the top electrode 13 and by the interlayer insulator 15, but most of the laser beam pass through the interlayer insulator 15 and the substrate 10. In this case, the laser beam is absorbed by the top electrode 13. Melting and re-crystallization occur, and the top electrode 13 is separated at this portion.

The projection of the laser beam as shown in FIG. 2 and FIG. 3 is continuously performed along an extending direction of the separating portion as shown by a symbol 22 in FIG. 1, As a result, a multiple of electron sources connected to the scan lines are perfectly separated for each of the scan lines.

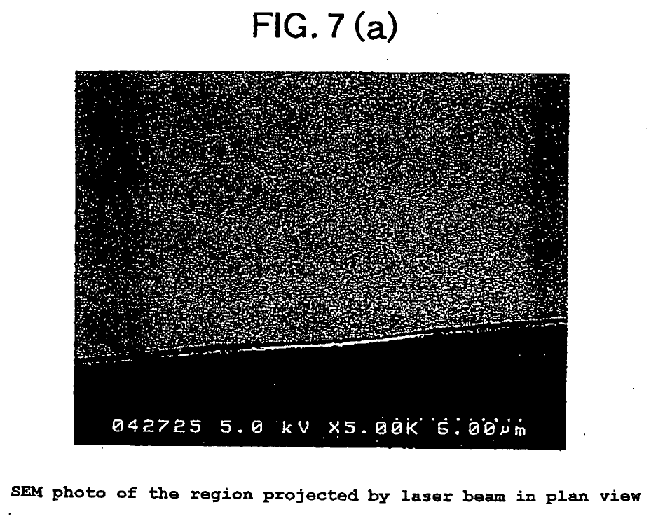

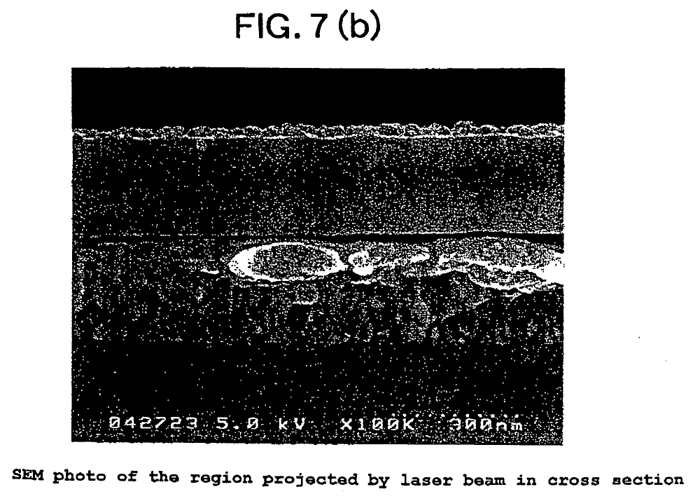

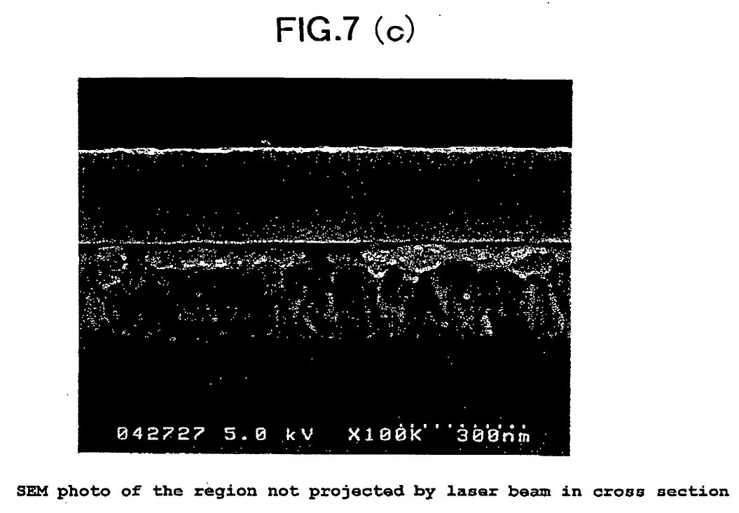

FIG. 7A is a SEM photograph of a region in plan view where the laser beam is projected on the top electrode on the data line shown in FIG. 2. FIG. 7B is a SEM photograph of a region in cross-section where laser beam is projected to the top electrode on the data line as shown in FIG. 2. FIG. 7C represents a SEM photograph of a region in cross-section when the laser beam is not projected to the top electrode on the data line shown in FIG. 2. According to the SEM photographs in plan view, it is evident that surface roughness is increased in the area projected by the laser beam compared with the region where the laser beam is not projected.

When we see the cross-sectional SEM photograph exactly, it is apparent that aggregation occurs on the top electrode in the projected region and crystal grains are present discretely. Naturally, it can be confirmed that the top electrode is in the state of a continuous film in the non-projected area.

Here, if it is supposed that width of the region projected by the laser beam (may be limited to visual field of cross-sectional SEM photo) is L, average grain size within the region along the width L is Rav, and the average number of crystal grains included in the region along the width L is Nav. it is evident that the following relation exists:
L>2×Nav×Rav

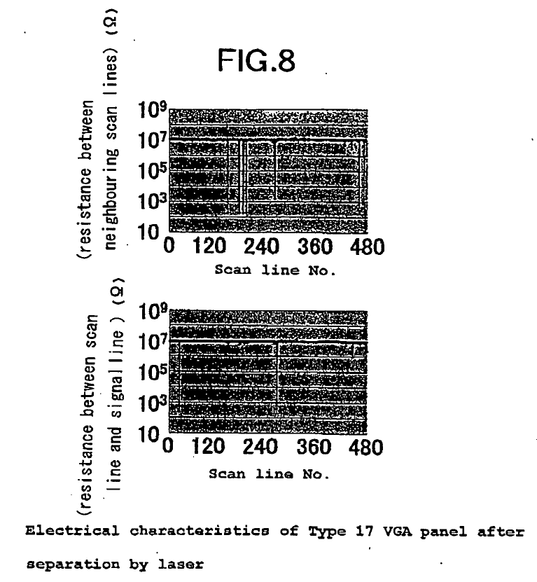

FIG. 8 shows the results of measurement of resistance on a type 17 VGA panel with the top electrode separated by the above method. In this case, resistance between the selected scan lines and the data lines and between adjacent scan lines (between bus with total length of about 400 mm) were measured under the condition that all of the data lines (640×3) were short-circuited and grounded. In the results of measurement, the resistance between the scan lines reached 10 MΩ or more by the laser beam projection. At the same time, there was no influence on the resistance with the data lines. This suggests that no influence is given on the interlayer insulator by this method, and that only the top electrode can be selectively processed.

### Embodiment 2

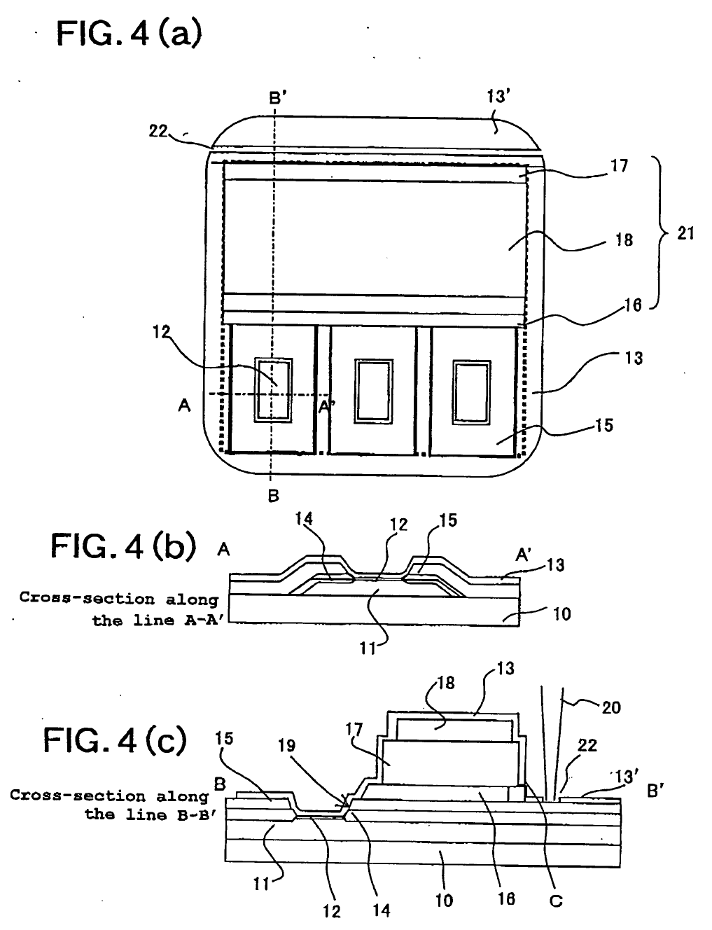

FIG. 4 shows drawings, each representing an electron source on a cathode substrate to explain the Embodiment 2 of the image display device of the present invention. FIG. 4(a) is a plan view of a color pixel, FIG. 4(b) is a cross-sectional view along the line A-A′ in FIG. 4(a), and FIG. 4(c) is a cross-sectional view along the line B-B′ in FIG. 4(a). The configuration of the cathode substrate is approximately the came as that of FIG. 1, while, in this Embodiment 2, the present invention is applied for the restoration of the defects, which may occur when the top electrode 13 is separated from the adjacent top electrode 13′ by the self-alignment as described above.

An eave is formed in the scan line bus intermediate layer 17 by retracting the scan line lower layer 16 from the scan line intermediate layer 17 on one side of the scan line. As a result, the top electrode 13 deposited on the upper layer of the scan line bus 21 is automatically separated by this eave. In this manufacturing process, photolithographic process is required by three times, i.e. on the scan line upper layer 18, on the scan line intermediate layer 17, and on the scan line lower layer 16,

Even when there may be a portion C, where the top electrode 13 thus deposited is not completely separated from the top electrode 13′ of the electron source connected to the adjacent scan line, the top electrode 13′ can be reliably separated from the top electrode 13 by projecting the laser beam in the same manner as in the Embodiment 1 and by forming a separating portion 22.

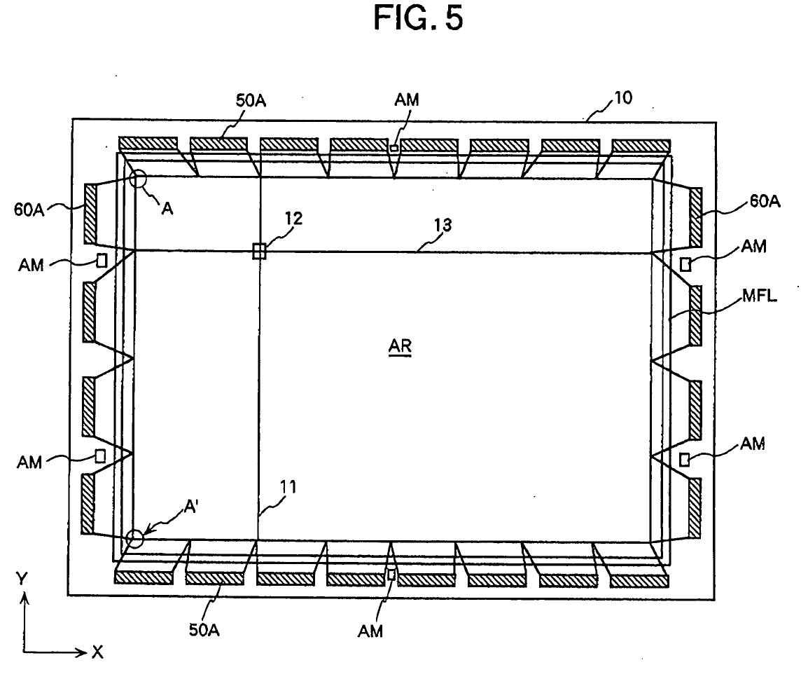

FIG. 5 is a plan view of the cathode substrate, which constitutes the image display device of the present invention. In FIG. 1, the electron source is shown by the tunneling insulator 12. The electron source arranged in matrix-like form is given by a display region AR. In FIG. 5 the symbol 50A denotes a data line driving circuit chip, and 60 represents a scan line driving circuit chip. A plurality of these chips make up together a data line driving circuit and a scan line driving circuit. The symbol AM is a position mark (alignment mark) with a phosphor substrate. Beside the alignment mark, various types of positioning marks (also called “target patterns”) to be used in the manufacturing process or codes for process control are included. The cathode substrate 10 is attached to the phosphor substrate (not shown) via a sealing frame (frame glass) MFL The sealing frame MFL is provided on the circumference of the display region AR. The separating portion 22 of the top electrode 13 as described above is formed along the top electrode 13 shown in FIG. 5.

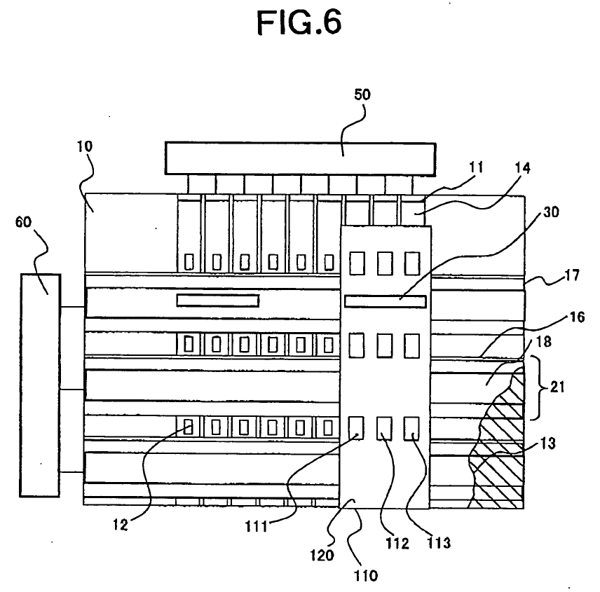

FIG. 6 is a drawing to explain the entire configuration of the image display device of the present invention. It is a schematical plan view taking an example on the image display device using MIM type thin film electron source. In FIG. 6, a plan view of one of the glass substrates (cathode substrates) 10 having the electron source is shown. The other of the glass substrates (phosphor substrates, display side substrates, color filter substrates) with a phosphor formed on it shows partially only a black matrix 120 on inner surface and phosphors 111, 112 and 113, and the substrate itself is not shown.

On the cathode substrate 10, there are provided a bottom electrode 11 to constitute data lines (data lines, signal electrode lines) connected to the data line driving circuit 50, the scan line bus (3-layer scan line bus) 21 connected to the scan line driving circuit 60 and arranged perpendicularly to the data lines, a field insulator 14, and other functional films (to be described later). The cathode (electron emitting unit; electron source) comprises the top electrode 13 connected to the scan lines and laminated on the bottom electrode 11 via the tunneling insulator, and electrons are emitted from a portion of the tunneling insulator 12.

On the other hand, on inner surface of a display side substrate 110, a light shielding layer to increase the contrast of the display image is provided. That is, a black matrix 120, a phosphor layer comprising a red phosphor 111, a green phosphor 112, and a blue phosphor 113, and an anode (not shown) are provided. As the phosphor, Y₂O₂S:Eu (P22-R) may be used as the red phosphor. ZnS:Cu, Al (P22-G) may be used as the green phosphor, and ZnS:Ag, Cl (P22-B) may be used as the blue phosphor. The cathode substrate 10 and the phosphor substrate 110 are maintained with a certain fixed distance between them via a spacer 30 of a glass plate or a ceramic plate. A sealing frame (not shown) is interposed on outer periphery of the display region, and the space inside is sealed under vacuum condition.

The spacer 30 is arranged on upper portion of the scan line 21 of the cathode substrate 10, and it is positioned so that it is concealed under the black matrix 120 of the phosphor substrate 110. The bottom electrode 11, serving as data line, is connected to the data line driving circuit 50. The scan line bus 21 with the top electrode in the upper layer is connected to the scan line driving circuit 60.

What is claimed is:

1. An image display device, configured in a vacuum container, comprising a cathode substrate arranged in matrix-like form with a multiple of electron sources arranged in a display region, a phosphor substrate having a phosphor layer and an anode corresponding to each of the electron sources, a sealing frame interposed between said cathode substrate and said phosphor substrate on circumference of the display region and for attaching the substrates with each other, said image display device further comprises:
a multiple of data lines arranged in parallel to said cathode substrate;
a multiple of scan lines arranged in parallel in a direction to perpendicularly cross said data line; and
electron emitting electrode for emitting electrons in contact with the electron source under vacuum condition;
wherein said electron emitting electrode has regions with locally high resistance and is divided to a plurality of independent electrodes.

2. An image display device according to claim 1, wherein high resistance region of said electron emitting electrode is formed by rough growth associated with melting and re-crystallization or by evaporation phenomenon.

3. An image display device according to claim 1, wherein, when it is supposed that width of said high resistance region in said electron flitting electrode in L, average grain size in the region along the width L is Rav, and average number of crystal grains contained in said region along the width L is Nav. the following relation exists:
L>2×Nav×Rav

4. An image display device according to claim 2, wherein, when it is supposed that width of said high resistance region in said electron emitting electrode is L, average grain size in the region along the width L is Rav, and average number of crystal grains contained in said region along the width L is Nav, the following relation exists:
L>2×Nav×Rav

5. An image display device according to claim 1, wherein said electron emitting electrode comprises a single layer or a lamination of two layers or more.

6. An image display device according to claim 1, wherein said electron source is in type of MIM, MIS, BSD, HEED, or SED.

7. An image display device according to claim 1, wherein said electron emitting electrode is a laminated thin film made of iridium, platinum, and gold from below.

8. A method for manufacturing an image display device, configured in a vacuum container, comprising a cathode substrate arranged in matrix-like form with a multiple of electron sources arranged in a display region, a phosphor substrate having a phosphor layer and an anode corresponding to each of the electron sources, a sealing frame interposed between said cathode substrate and said phosphor substrate on circumference of the display region and for attaching the substrates with each other, wherein said method comprises the steps of:
forming a multiple of data lines arranged in parallel to said cathode substrate;
forming a plurality of scan lines arranged in parallel in a direction to cross said data lines;
having an electron emitting electrode for emitting electrons under vacuum condition from said electron sources; and
dividing said electron emitting electrode to a plurality of independent electrodes by setting said electron emitting electrode with locally high resistance.

9. A method for manufacturing an image display device according to claim 8, wherein the setting of said electron emitting electrode to locally high resistance is executed by inducing grain growth and aggregation by local heating.

10. A method for manufacturing an image display device according to claim 9, wherein:
said electron source is a thin film type electron source, comprising a bottom electrode, a top electrode, and an electron accelerator interposed therebetween;
said local heating is executed by projection of a laser beam, and when it is supposed that the wavelength of the laser used is λ, a condition is satisfied where spectroreflective property in a first region with the data lines among a region projected by the laser is turned approximately to the minimum value at the wavelength λ, i.e. a first condition where a reflection wave on boundary surface between the top electrode and the uppermost layer and a reflection wave on boundary surface between the insulator of the lowermost layer and the data line metal interfere with each other and negate each other, said first condition being
Σti×ni≈N×λ/2
j
where N: arbitrary integer, and
j :sum for the insulator in said first region; and
a second condition is satisfied where spectroreflective property in a second region without data lines among the regions projected by the laser is turned to the minimum value at the wavelength of λ, i.e. a reflection wave on boundary surface between the top electrode and the uppermost layer and a reflection wave on boundary surface between the insulator of the lowermost layer and the glass interfere with each other and negate each other, said second condition being
Σti×ni≈(2N+1)×λ/4
k
where N: arbitrary positive integer, and
k: sum for the insulator in the second region.
